(19) United States
(12) Patent Application Publication
(10) Pub. No.: US 2008/0239867 A1
(43) Pub. Date: Oct. 2, 2008

(54) Adjustable stir

(76) Inventor: Donna J. Gilbert, La Crosse, WI (US)

Correspondence Address: JAMES RAY & ASSOCIATES, 2640 PITCAIRN ROAD, MONROEVILLE, PA, 15146, US

(21) Appl. No.: 12/079,101

(22) Filed: Mar. 25, 2008

Related U.S. Application Data
(60) Provisional application No. 60/908,425, filed on Mar. 28, 2007.

(51) Int. Cl. B01F 13/08; B01F 15/06

(52) U.S. Cl. 366/146; 366/144

(57) ABSTRACT

In combination with a stove having a plurality of burners on an upper surface thereof and a control panel, the improvement comprises a magnetic stir device disposed in a central portion of and beneath at least one burner of the stove. The magnetic stir device includes a T-shaped attachment having a rotating rod and a magnetic bar disposed at the top of the rotating rod and a motor means engageable with a base portion of the T-shaped attachment. A control means is in electrical communication with the magnetic stir device and is disposed in close proximity to the stove's control knobs. The control means provides a plurality of stirring speeds. A power means is connected to the motor means and the control means for providing power. A stir bar having a predetermined size is disposed in a bottom of cookware, containing material to be stirred, that is disposed on the at least one burner having the magnetic stir device disposed therein. The stir bar is in close proximity to the magnetic bar of the T-shaped attachment of the magnetic stir device.

### CROSS REFERENCE TO RELATED APPLICATIONS

This application is closely related to and claims benefit from U.S. Provisional Application Ser. No. 60/908,425 filed Mar. 28, 2007.

### FIELD OF THE INVENTION

The present invention relates, in general, to a stirring mechanism, and, more particularly, the present invention relates to stirring mechanism that incorporated in a stove and utilizes a magnetic type stirrer.

### BACKGROUND OF THE INVENTION

When preparing a sauce, soup or other viscous fluid, the cook needs to constantly check and stir the liquid in order to prevent burning and scorching of the bottom of the pan or stock pot. This is especially necessary when working with cream or milk bases, as well as preparing a roux, since these are easily ruined if the cook is not careful. If the sauce burns, the cook will have to start the dish over again. But, as many home or professional cooks will attest to, it is difficult and annoying to constantly have to stir the sauce, since this leaves little opportunity to complete other tasks or prepare additional aspects of the recipe. This is particularly true since many cooks, particularly a home cook, or even professional chefs do not have the luxury of any extra kitchen help.

Thus, it would be advantageous if there were an apparatus or a tool that would stir the sauce or other viscous fluid being prepared automatically, effectively eliminating the need to constantly stand over the pot, stirring and stirring in order to prevent scorching.

### SUMMARY OF THE INVENTION

In a first aspect the present invention provides in combination with one of an electric stove and a gas stove having a plurality of burners on an upper surface thereof and a control panel, the improvement comprises a magnetic stir device disposed in a central portion of and beneath at least one burner of the stove. The magnetic stir device includes a T-shaped attachment having a rotating rod and a magnetic bar disposed at a top of the rotating rod and a motor means engageable with a base portion of the T-shaped attachment for rotating such T-shaped attachment. A control means is in electrical communication with the magnetic stir device and is disposed in close proximity to the stove's control knobs that are disposed on the stove's control panel. The control means provides a plurality of stirring speeds. A power means is connected to each of the motor means and the control means for providing power to the control means and the magnetic stir device. A stir bar having a predetermined size is disposed in a bottom of cookware, containing one of a liquid, roux and a sauce to be stirred, that is disposed on the at least one burner having the magnetic stir device disposed therein. The stir bar is in close proximity to the magnetic bar of the T-shaped attachment of the magnetic stir device.

In a second aspect the present invention provides a method for stirring one of a liquid, roux and a sauce on a stove equipped with a magnetic stir device, that includes a T-shaped attachment and a motor means, disposed therein, the method comprises the steps of selecting an appropriate sized saucepan for such one of liquid, roux and sauce to be blended. There is step of placing a stir bar sized to fit the appropriate sized sauce pan into the appropriate sized sauce pan. A step of adding one of such liquid, roux and sauce to be blended into the saucepan and turning on the magnetic stir device. There is a step of rotating such stir bar by use of the magnetic stir device and selecting an appropriate stirring speed. A step of turning off the magnetic stir device and removing the stir bar by use of a magnetic wand after stirring is complete and one of such liquid, roux and sauce is thoroughly blended.

### OBJECTS OF THE INVENTION

It is, therefore, one of the primary objects of the present invention to provide a magnetic stir device installed into one of a gas or electric stove.

Another object of the present invention to provide a magnetic stir device that is disposed in a center portion and below a burner in the stove.

Still another object of the present invention to provide a magnetic stir device that has a control means disposed closely adjacent the control knobs of the stove.

Yet another object of the present invention to provide a magnetic stir device that includes a stir bar placed in a saucepan containing the liquid to be blended.

Another object of the present invention is to provide a method for stirring such liquid to be blended by using such magnetic stir device.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a side perspective view of a stove showing the magnetic stir device disposed in a center and under a burner of the stove.

FIG. 2 is a perspective view of a sauce pan with a stir bar disposed therein placed on the burner of the stove.

FIG. 3 is a perspective view of two different sized sauce pans having different sized stir bars disposed therein.

FIG. 4 is a side perspective view of a sauce pan with the stir bar being removed by a magnetic wand.

FIG. 5 is a perspective view of the components of the invention.

FIG. 6 is a front angle perspective view of a stove showing the control means disposed on the control panel.

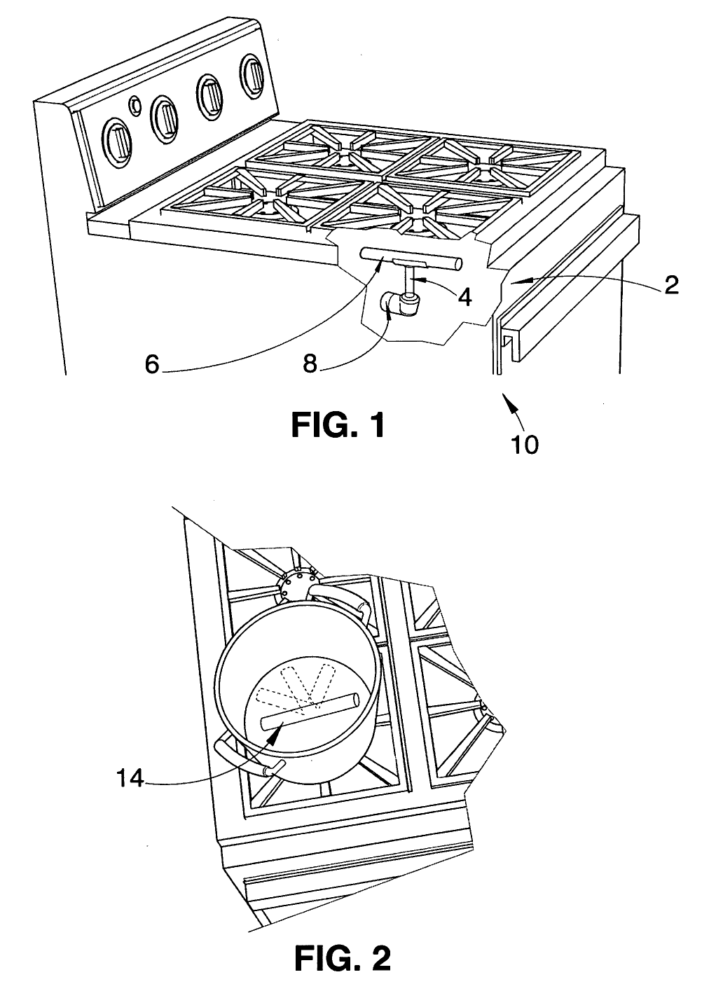

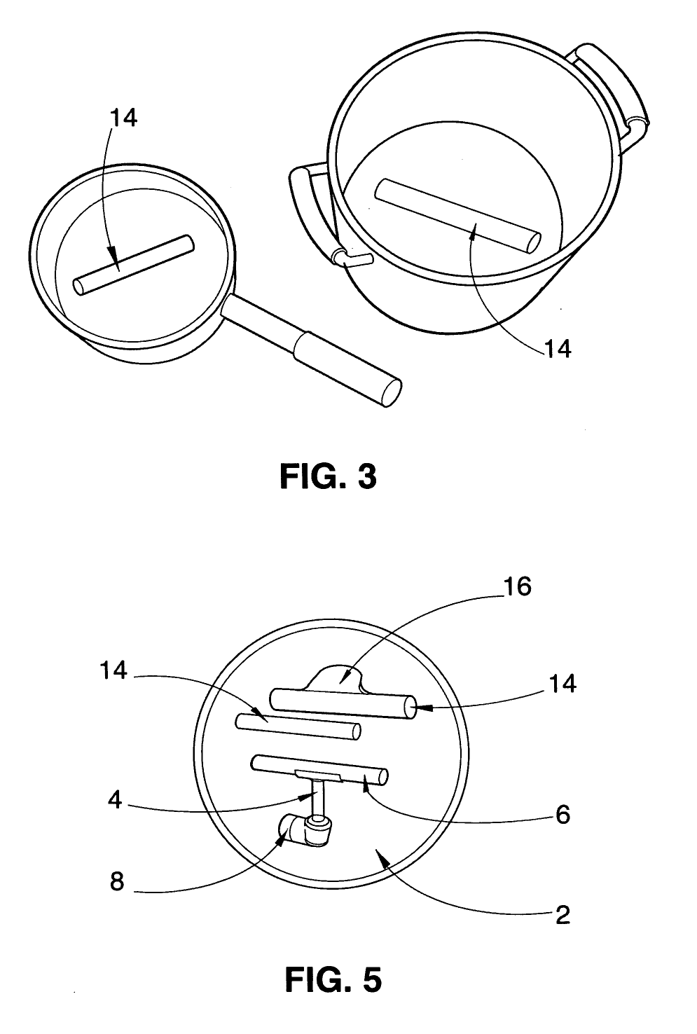

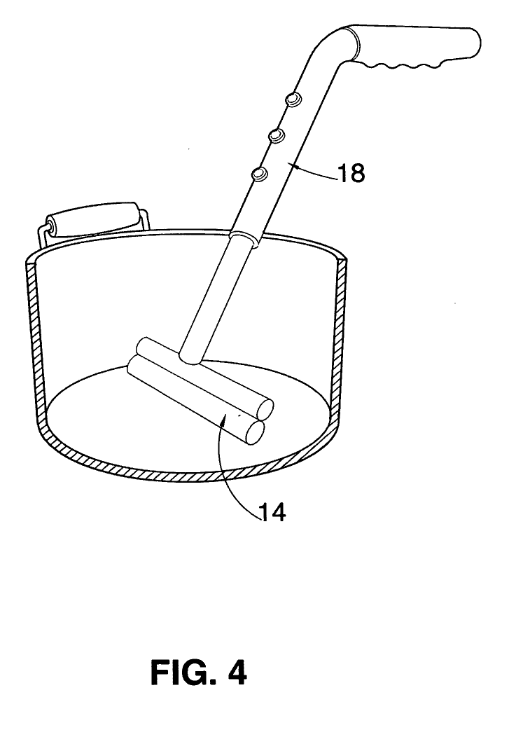

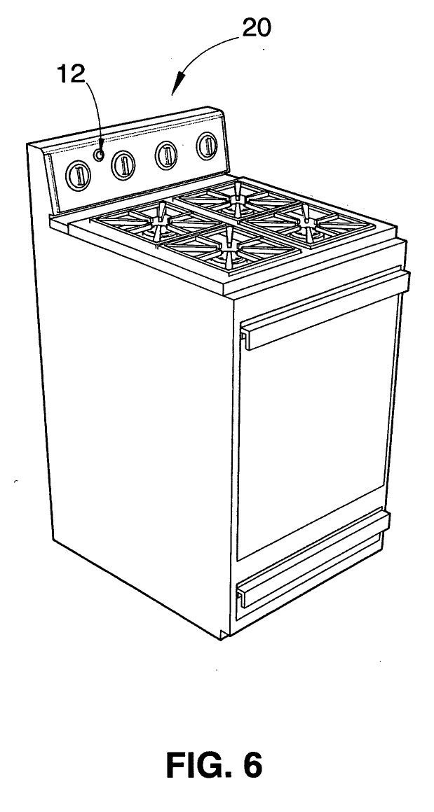

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides in combination with one of an electric stove and a gas stove having a plurality of burners on an upper surface thereof and a control panel, the improvement comprises a magnetic stir device, generally designated 10, disposed in a central portion of and beneath at least one burner of the stove. The magnetic stir device 10 includes a T-shaped attachment 2 having a rotating rod 4 and a magnetic bar 6 disposed at a top of the rotating rod 4 and a motor means 8 engageable with a base portion of the T-shaped attachment 2 for rotating such T-shaped attachment 2. A control means 12 is in electrical communication with the magnetic stir device 10 and is disposed in close proximity to the stove's control knobs that are disposed on the stove's control panel. The control means 12 provides a plurality of stirring speeds. A power means, generally designated 20, is connected to each of the motor means 8 and the control means 12 for providing power to the control means 12 and the magnetic stir device 2. It is presently preferred that such power means 20 would be the existing electrical 110V circuit in the stove. A stir bar 14 having a predetermined size is disposed in a bottom of cookware, containing one of a liquid, roux and a sauce to be stirred, that is disposed on the at least one burner having the magnetic stir device 2 disposed thereunder. The stir bar 14 is in close proximity to the magnetic bar 6 of the T-shaped attachment 2 of the magnetic stir device 10. Such stir bar 14 is magnetic so that when such rotating rod 4 of the T-shaped attachment 2 is rotated causing the magnetic bar 6 to rotate thereby causing such stir bar 14 to rotate. As the stir bar 14 rotates it stirs the liquid, roux or sauce and blends them. It is presently preferred that such stir bar 14 be coated with plastic and further preferred that such plastic is a silicone. This will aid in preventing any of the material being stirred from sticking to the stir bar 14.

In an alternate embodiment of the stir bar 14, the stir bar includes a fin shaped head 16 for creating a vortex when the stir bar 14 is rotated so as to thoroughly blend such liquid or other material in such cookware.

The magnetic stir device 10 further includes an adjustable magnetic wand 18. Such magnetic wand 18 is used to remove the stir bar 14 when stirring is complete. This is important because the material may be thick and it would be difficult to get to the stir bar 14. With the wand 18 inserted in the material that was stirred the stir bar 14 will stick to the magnetic wand 10 and is easily removed. Such magnetic wand 18 further includes a handle portion disposed on an end thereof for ease of manipulating the magnetic wand 18.

The magnetic stir device 10 is independent of the burner. That is it can be used with the burner being in an off position or it can be used with the burner on thereby providing heat for the material in the saucepan while being stirred.

It is within the scope of the invention that such stir bar 14 has a plurality of predetermined sizes. This is important because the size of the stir bar should correspond to the size of the sauce pan being used. Thus, the plurality of sizes for the stir bar includes a stir bar sized to fit into a 1 quart saucepan, another stir bar sized to fit into a 1½ quart saucepan and another stir bar sized to fit into a 3 quart sauce pan. Although the discussion supra concerns different size stir bars 14 for different size sauce pans, it should be noted that it is not critical that the stir bar 14 be the size of the sauce pan. That is, a small stir bar 14 could be used with a large sauce pan and still achieve stirring or a large stir bar 14 could be used with a small sauce pan as long as it was free to rotate. However, the stirring is probably more efficient if the stir bar more closely matches the size of the sauce pan.

The control means 12 provides a plurality of stirring speeds which would include at least six different speeds and it is preferred that there would be ten different stirring speeds.

In a second aspect the present invention provides a method for stirring one of a liquid, roux and a sauce on a stove equipped with a magnetic stir device 10, that includes a T-shaped attachment 2 and a motor means 8, disposed therein, the method comprises the steps of selecting an appropriate sized saucepan for such one of liquid, roux and sauce to be blended. There is step of placing a stir bar 14 sized to fit the appropriate sized sauce pan into the appropriate sized sauce pan. A step of adding one of such liquid, roux and sauce to be blended into the saucepan and turning on the magnetic stir device 10. There is a step of rotating such stir bar 14 by use of the magnetic stir device 10 and selecting an appropriate stirring speed at the control means 12. A step of turning off the magnetic stir device 10 and removing the stir bar 14 by use of a magnetic wand 18 after stirring is complete and one of such liquid, roux and sauce is thoroughly blended. 15. The method further includes the step of removing such one of liquid, roux and sauce from the saucepan. The method also includes a step of whipping such one of a liquid, roux or sauce by using a stir bar 14 with a fin shaped head 16.

Thus, the present invention of an adjustable stirring mechanism provides a convenient kitchen device. It provides a two part system. The primary unit of the stirring mechanism is integrated into the design of a stove. The base unit is a magnetic stir device that is located in the middle of the stove's burner and below the burner so as to not be affected by the heat of the burner. The magnetic stir device contains a motor with a T-shaped attachment consisting of a rotating rod and a magnetic bar. The unit includes a control portion located in close proximity to the stove's existing control knobs. The control unit will provide variable speed levels to ensure that a proper stirring speed is available. There will be provided approximately 10 stirring levels.

The second part of the adjustable stirring mechanism is a stir bar. The stir bar is constructed of metal which is coated with silicone similar to existing kitchen utensils. The bar is placed in the bottom of the cookware containing the material to be stirred. The rotating magnet will propel the bar around the bottom of the pot or pan. The bar could also be made with a fin shaped head which will even enable vigorous whipping to occur. As the stir bar moves, a vortex or funnel shaped is created and the sauce or liquid will be thoroughly blended. Although the stir bar can be made in various sizes it should be large enough as to not fall into the sink's garbage disposal if it is accidentally dropped into the sink. The bar comes in various lengths to accommodate differences in pot and pan dimensions.

When stirring is complete, an adjustable magnet wand with a handle is used to remove the stir bar from the cookware. Two different versions are envisioned so that the device can be used with either gas or electric stoves. As the stirring mechanism is independent of the stove burner it can be used with or without heat. The stirring mechanism can be used with both thin and viscous liquids ensuring that a wide range of soups, sauces gravies, and beverages can be created with the device. While the adjustable stirring mechanism is helpful for any cooking enthusiast it especially useful in a more professional cooking situation.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. In combination with one of an electric stove and a gas stove having a plurality of burners on an upper surface thereof and a control panel, the improvement comprising:
(a) a magnetic stir device disposed in a central portion of and beneath at least one burner of said stove, said magnetic stir device including;
(i) a T-shaped attachment including a rotating rod and a magnetic bar disposed at a top of said rotating rod;
(ii) a motor means engageable with a base portion of said rotating rod of said T-shaped attachment for rotating said T-shaped attachment;
(b) a control means in electrical communication with said magnetic stir device disposed in close proximity to control knobs disposed on said stove's control panel, said control means for providing a plurality of stirring speeds;
(c) a power means connected to each of said motor means and said control means for providing power to said control means and said magnetic stir device; and
(d) a stir bar having a predetermined size disposed in a bottom of cookware containing a liquid to be stirred disposed on said at least one burner having said magnetic stir device disposed therein, said stir bar in close proximity to said magnetic bar of said T-shaped attachment of said magnetic stir device.

2. The combination, according to claim 1, wherein said stir bar is magnetic.

3. The combination, according to claim 1, wherein said stir bar is coated with a plastic coating.

4. The combination, according to claim 3, wherein said plastic coating is a silicone.

5. The combination, according to claim 2, wherein said stir bar further includes a fin shaped head for creating a vortex when said stir bar is rotated so as to thoroughly blend such liquid in such cookware.

6. The combination, according to claim 1, wherein said combination further includes an adjustable magnetic wand for removal of said stir bar when stirring is complete.

7. The combination, according to claim 6, wherein said magnetic wand includes a handle portion disposed on an end thereof for ease of manipulating said magnetic wand.

8. The combination, according to claim 1, wherein said magnetic stir device is independent of whether said burner in which said magnetic stir device is disposed is one of in an on position and an off position.

9. The combination, according to claim 1, wherein said stir bar has a plurality of predetermined sizes.

10. The combination, according to claim 1, wherein said predetermined size of said stir bar corresponds to whatever cookware is being used.

11. The combination, according to claim 1, wherein said plurality of sizes for said stir bar includes a stir bar sized to fit into a 1 quart saucepan, another stir bar sized to fit into a 1½ quart saucepan and another stir bar sized to fit into a 3 quart sauce pan.

12. The combination, according to claim 1, wherein said plurality of stirring speeds includes at least six different stirring speeds.

13. A method for stirring a liquid on a stove equipped with a magnetic stir device, including a T-shaped attachment and a motor means, disposed therein, said method comprising the steps of:
(a) selecting an appropriate sized saucepan for such one of liquid, roux and sauce to be blended;
(b) placing a stir bar sized to fit said appropriate sized sauce pan into said appropriate sized sauce pan;
(c) adding said one of liquid, roux and sauce to be blended into said saucepan;
(d) turning on said magnetic stir device;
(e) rotating said stir bar by use of magnetic stir device;
(f) selecting an appropriate stirring speed;
(g) stirring said one of liquid, roux and sauce until completely blended; and
(g) turning off said magnetic stir device.

14. The method, according to claim 13, wherein said method further includes a step of removing said stir bar by use of a magnetic wand.

15. The method, according to claim 14, wherein said method further includes the step of removing said one of liquid, roux and sauce from said saucepan.

16. The method, according to claim 13, wherein said method further includes a step of whipping said one of liquid, roux and sauce by using a stir bar with a fin shaped head.
